(19) United States
(12) Patent Application Publication
(10) Pub. No.: US 2024/0303687 A1
(43) Pub. Date: Sep. 12, 2024

(54) Attribution Model for Related and Mixed Content Item Responses

(71) Applicant: Google LLC, Mountain View, CA (US)

(72) Inventors: Laura Marie Eidem, Mountain View, CA (US); Alex Daniel Jacobson, Los Altos, CA (US)

(21) Appl. No.: 17/769,942

(22) PCT Filed: May 4, 2021
(86) PCT No.: PCT/US2021/030712

§ 371 Date: Apr. 18, 2022

(51) Int. Cl. G06Q 30/0241

(52) U.S. Cl. CPC G06Q 30/0241

(57) ABSTRACT

Systems, methods, and computer-readable storage media utilized to determine product response for analysis systems. One method includes receiving a product response for a first product, the product response including interaction data indicating a user interaction with a content item of a second product, wherein the content item is associated with a content provider, and identifying a relatedness graph of a plurality of products. The method further includes aggregating weights of measures of degrees of relatedness in the relatedness graph of a first node of the first product to a second node of the second product, and generating a relatedness index based on normalizing the aggregation of the weights of the measures of degrees. The method further includes, in response to the relatedness index exceeding a threshold, calculating an attribution credit assigned to the product response based on the relatedness index, and providing the attribution credit to the content provider.

### BACKGROUND

The present disclosure relates generally to the field of attribution models. In a computer networked environment such as the internet, attribution models have been used in an effort to predict the impact of content.

### SUMMARY

Some implementations relate to a method for determining related product responses, the method implemented by one or more processing circuits. The method includes receiving a product response for a first product, the product response comprising interaction data indicating a user interaction with a content item of a second product, wherein the content item is associated with a content provider. Further, the method includes identifying a relatedness graph of a plurality of products. Further, the method includes aggregating weights of measures of degrees of relatedness in the relatedness graph of a first node of the first product to a second node of the second product. Further, the method includes generating a relatedness index based on normalizing the aggregation of the weights of the measures of degrees. Further, the method includes, in response to the relatedness index exceeding a threshold, calculating an attribution credit assigned to the product response based on the relatedness index. Further, the method includes providing the attribution credit to the content provider of the content item.

In some implementations, the method further includes receiving a pingback correction indicating the product response was remitted from an entity computing system associated with the first product, updating the attribution credit reflecting the remitted product response, and providing the updated attribution credit to the content provider. In various implementations, the method further includes identifying, by the one or more processors, a trend in the product response based on analyzing the interaction data and historical interaction data of previous product responses, in response to identifying the trend, determining a different content item associated with the first product and modifying a content item slot of the content item with the different content item. In some implementations, the method further includes, in response to identifying the trend, calculating new weights of the measures of degrees between the first node and the second node, and updating the relatedness graph with the new weights of the measures of degrees between the first node and the second node. In various implementations, the relatedness graph comprises a plurality of nodes including the first node and the second node, and wherein each node of the plurality of nodes is associated with a product of the plurality of products. In some implementations, each measure of degree of the measures of degrees connecting the plurality of nodes of the relatedness graph are weighted based on relationships between the plurality of products, wherein the relationships are at least one of an entity explicit designation of a relative weighting between the relationships, product identifiers, one or more taxonomies, one or more n-gram sequences, or user device data. In various implementations, normalizing comprises linearly weighting the weights of the measures of degrees between the first node and the second node and scaling the linearly weighted weights of the measures of degrees to a scale of 1.0. In some implementations, the threshold is based on at least one of a first sensitivity set by an entity, a second sensitivity set by the content provider, the content item, the first product, or the second product, and wherein the interaction data comprises a timestamp associated with an event, and user device data.

Some implementations relate to a method for determining full product responses, the method implemented by one or more processing circuits. The method includes receiving a product response for a first product and a second product, the product response comprising interaction data indicating a user interaction with a content item of the second product, wherein the content item is associated with a content provider. Further, the method includes calculating a first attribution credit assigned to the product response. Further, the method includes identifying a relatedness graph of the plurality of products. Further, the method includes aggregating weights of measures of degrees of relatedness in the relatedness graph of a first node of the first product to a second node of the second product. Further, the method includes generating a relatedness index based on normalizing the aggregation of the weights of the measures of degrees. Further, the method includes, in response to the relatedness index exceeding a threshold, calculating a second attribution credit assigned to a full product response based on the relatedness index. Further, the method includes providing the first attribution credit and the second attribution credit to the content provider of the content item.

In some implementations, the method further includes receiving a pingback correction indicating the full product response was remitted from an entity computing system associated with the first product, updating the second attribution credit reflecting the remitted product response, and providing the updated second attribution credit to the content provider. In various implementations, the method further includes identifying a trend in the product response based on analyzing the interaction data and historical interaction data of previous product responses, in response to identifying the trend, determining a different content item associated with the first product, and modifying a content item slot of the content item with the different content item. In some implementations, the method further includes, in response to identifying the trend, calculating new weights of the measures of degrees between the first node and the second node, and updating the relatedness graph with the new weights of the measures of degrees between the first node and the second node.

Some implementations relate to a system with at least one processing circuits. The at least one processing circuit can be configured to receive a product response for a first product, the product response comprising interaction data indicating a user interaction with a content item of a second product, wherein the content item is associated with a content provider. Further, the at least one processing circuit can be configured to identify a relatedness graph of a plurality of products. Further, the at least one processing circuit can be configured to aggregate weights of measures of degrees of relatedness in the relatedness graph of a first node of the first product to a second node of the second product. Further, the at least one processing circuit can be configured to generate a relatedness index based on normalizing the aggregation of the weights of the measures of degrees. Further, the at least one processing circuit can be configured to in response to the relatedness index exceeding a threshold, calculating, by the one or more processing circuits, an attribution credit assigned to the product response based on the relatedness index. Further, the at least one processing circuit can be configured to provide the attribution credit to the content provider of the content item.

In some implementations, the at least one processing circuit can be configured to receive a pingback correction indicating the product response was remitted from an entity computing system associated with the first product, update the attribution credit reflecting the remitted product response, provide the updated attribution credit to the content provider. In various implementations, the at least one processing circuit can be configured to identify a trend in the product response based on analyzing the interaction data and historical interaction data of previous product responses, in response to identifying the trend, determine a different content item associated with the first product, and modify a content item slot of the content item with the different content item. In some implementations, he at least one processing circuit can be configured to, in response to identifying the trend, calculate new weights of the measures of degrees between the first node and the second node, and update the relatedness graph with the new weights of the measures of degrees between the first node and the second node. In various implementations, the at least one processing circuit can be configured to update the attribution credit reflecting product response comprising the first product and the second product, and provide the updated attribution credit to the content provider.

Some implementations relate to one or more computer-readable storage media having instructions stored thereon that, when executed by at least one processing circuit, cause the at least one processing circuit to perform operations. The operations include receiving a product response for a first product, the product response comprising interaction data indicating a user interaction with a content item of a second product, wherein the content item is associated with a content provider. Further, the operations includes identifying a relatedness graph of a plurality of products. Further, the operations include aggregating weights of measures of degrees of relatedness in the relatedness graph of a first node of the first product to a second node of the second product. Further, the operations include generating a relatedness index based on normalizing the aggregation of the weights of the measures of degrees. Further, the operations include, in response to the relatedness index exceeding a threshold, calculating an attribution credit assigned to the product response based on the relatedness index. Further, the operations include providing the attribution credit to the content provider of the content item.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram of an analysis system and associated environment, according to an illustrative implementation;

FIG. 2 is a flow chart for a method for determining related product responses, according to an illustrative implementation;

FIG. 3 is a flow chart for a method for determining full product responses, according to an illustrative implementation;

FIG. 4 is an example representation of a relatedness graph, according to illustrative implementations;

FIG. 5 is a block diagram of a computing system, according to an illustrative implementation.

### DETAILED DESCRIPTION

The present disclosure pertains to systems and methods that relate generally to determining full product responses and related product responses of content items. An attribution model can be used to measure the impact of the presentation of one or more content items on one or more resources (e.g., webpages, mobile applications, videos, smart assistants). In some embodiments, third-party attribution models can attribute a single product to a single content item, but cannot attribute related products or mixed products (e.g., more than the single product) to a single content item. That is, attribution models can be trained to attribute credit (or an attribution value) to content providers when a product response occurs for a single product associated with a single content item. However, content items associated with different products that provide user responses can go unattributed (e.g., discarded and/or marginalized) even though they may be related (e.g., headphones response after selecting a content item associated with a phone). Further, mixed responses that include multiple products may be undervalued or overvalued based on a content item of a single product. Thus, the systems and methods described herein relate to accurately attributing related product responses and mixed product responses from user interactions with content items.

In many systems, content providers can develop initiatives where they frequently employ content items associated with a product of an entity across content networks. Attribution models can be used to estimate the impact that a content item has on a response (e.g., based on causation). However, when product responses are received from a different product than the product associated with a content item, it makes it challenging to accurately assign attribution credit to content items based on the different product. Thus, the ability to attribute related products or mixed product bundles, such that attribution credits can be assigned accurately without undervaluing, overvaluing, or unvaluing a response, provides attribution models with enhanced performance and efficiency while reducing the amount of unvalued responses. This causal approach allows attribution models to provide significant improvements to predictions such that the accuracy of the prediction and the performance of the attribution model is improved and as a result, enabling content providers to make informed decisions about their initiatives. Therefore, aspects of the present disclosure address problems in attribution modelling architectures by designing an attribution model that utilizes relatedness graphs to generate relatedness indexes for assigning attribution credit to a content provider of content items.

Accordingly, the present disclosure includes systems and methods for determining related product responses and full product responses from user interactions with content items. In some implementations, the described systems and methods involve utilizing relatedness graphs. The relatedness graphs can be represented by a series of vectors between nodes (e.g., products), each with their own weight of relatedness, that can be aggregated and normalized to establish a relatedness index between two or more nodes. In various implementations, the weight of relatedness can be based on numerous factors such as, but not limited to, computational linguistics and probabilities, taxonomies, product data, user customized, behavioral data, financial data, etc. Furthermore, the relatedness index can be utilized to calculate an attribution credit for related product response and full product responses. Thus, the systems and methods described herein enable the attribution models to improve the accuracy of the predictions without discarding and/or unvaluing different products that may be related, or part of a mixed product bundle of the product associated with the content item. In particular, this technical solution provides a significant improvement to attribution modelling architectures that calculate attribution credits for responses. In some implementations, the attribution model can also update and/or modify attribution credit of related product response and full product response after the entity provides a credit back to the user of the related product response and full product response.

Furthermore, by using an improved attribution modelling architecture, aspects of this technical solution can decrease the amount of data discarded, which is a significant improvement over other attribution modelling architectures. That is, by using a relatedness graph, this technical solution can provide accurate estimations of related product responses and full product responses without transmitting inquires and/or requests for protected or private information (e.g., financial information, internet history, identifiers, etc.) of users and/or entities to determine the impact that a content item had on a response of the user. This not only protects attribution models and databases associated with them from exposing the protected or private information of users and/or entities, but also protects client devices from exposing their protected or private information, which is a significant improvement to the security of networking systems.

In situations in which the systems discussed here collects personal information about users and/or entities, or may make use of personal information, the users and/or entities are provided with an opportunity to control whether programs or features collect user information and/or entity information (e.g., information about a user's social network, social actions or activities, profession, a user's preferences, or a user's current location), or to control whether and/or how to receive content from the content server that may be more relevant to the user and/or entity. In addition, or in the alternative, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user and/or entity have control over how information is collected about the user and/or entity and used by a content server.

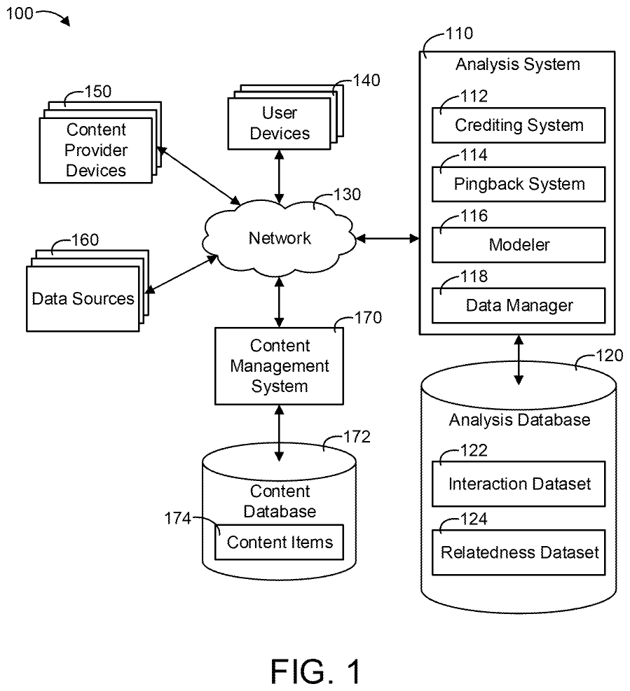

Referring now to FIG. 1, a block diagram of an analysis system 110 and associated environment 100 is shown, according to an illustrative implementation. One or more user devices 140 (e.g., smartphones, tablets, computers, etc.) may be used by a user to perform various actions and/or access various types of content, some of which may be provided over a network 130 (e.g., the Internet, LAN, WAN, etc.). A “user” or “entity” used herein may refer to an individual operating user devices 140, interacting with resources or content items via the user devices 140, etc. The user devices 140 may be used to send data to the analysis system 110 or may be used to access websites (e.g., using an internet browser), access mobile applications, access videos (e.g., television, livestreams), media files, communicate with smart assistants, and/or any other types of content. In some implementations, the user devices 140 have enabled location services which can be tracked over network 130. Locations services may use GPS or other technologies to determine a location of user devices 140.

The content provider devices 150 may specify an input (e.g., spend amount), a set of one or more content items (e.g., some or all items associated with a campaign including products), as well as one or more product lists associated with one or more third-parties. The analysis system 110 can be configured to generate relatedness graphs based on information received from the content provider devices 150 and/or with other information from other devices/systems described herein.

A content management system 170 may be configured to select content for display to users within resources (e.g., webpages, mobile applications (e.g., Google Chrome, Google Shipping, Google Pay), videos (e.g., on YouTube, Google Play), etc.) and to provide content items to the user devices 140 over the network 130 for display within the resources. The content from which the content management system 170 selects items may be provided by one or more content providers via the network 130 using one or more content provider devices 150. In some implementations, the content management system 170 may select content items from content providers 150 to be displayed on the user devices 140 (e.g., via a website, mobile application, and/or video etc.). In such implementations, the content management system 170 may determine content to be published in one or more content interfaces of resources (e.g., webpages, mobile applications, videos, etc.).

The content management system 170 can be communicably and operatively coupled to the content database 172 which may be configured to store a variety of information relevant to content items and content item slots. Information may be received from analysis system 110, user devices 140, content provider devices 150, and/or data sources 160, for example. The content management system 170 can be configured to query the content database 172 for information and store information in the content database 172. In various implementations, the content database 172 includes various transitory and/or non-transitory storage mediums. The storage mediums may include but are not limited to magnetic storage, optical storage, flash storage, RAM, etc. The content database 172 and/or the content management system 170 can use various APIs to perform database functions (i.e., managing data stored in the content items 174). The APIs can be but are not limited to SQL, NoSQL, NewSQL, ODBC, JDBC, etc.

The third-party systems 180 can be computing devices associated with entities that provide input (e.g., content spend) to content provider devices 150 in an attempt to receive responses associated with one or more products of the entity. Third-party systems 180 can be an internet commerce system (or “e-commerce system,” e.g., business to business (B2B), business to customer (B2C), customer to customer (C2C), or customer to business (C2B)) configured to provide interfaces (e.g., graphical user interface (GUI)) to the user devices 140, via a website (e.g., using an internet browser), via a mobile application (e.g., Google Chrome, Google Maps, Gmail), via videos (e.g., television, livestreams), via a smart assistant (e.g., Google Assistant). In some embodiments, the third-party systems 180 may host a customized interface at a uniform resource locator (URL) by host devices (e.g., computing device) and a collection of files defining the customized interface and stored on the host devices (e.g., in a database). Each third-party system may host a combination of one or more websites, mobile applications, or videos that can present digital content.

In various embodiments, the third-party systems 180 may host a customized interface on a mobile application stored on the user devices 140 and downloaded in an application store. As such, each third-party system (e.g., 180) may include a shopping experience for a user. The user can be redirected to provide a response (e.g., make a purchase of a product or service) based on selecting a content item in a content item slot hosted by the content provider devices 150 and/or content management system 170. For example, upon selection of a content item, a mobile application on the user device may present a response opportunity for a customer. In another example, upon selection of a content item in a video, the user device may be redirected to a website of the third-party system to complete a response. The redirection (e.g., based on a click or selection) may include interaction data associated with the content item. This interaction data can be passed or provided to the third-party systems 180 as packets of data and any additional interactions on the third-party system 180 can also be recorded and stored as packets of interaction data. In some embodiments, upon a product response, the packets of interaction data including the product response and activity logs may be sent to analysis system 110 for analysis (e.g., determining related product responses and/or full product responses). Furthermore, the analysis system 110 and third-party system 180 can be communicably coupled using various APIs to exchange data (i.e., managing product responses and interaction data stored in the analysis database 120). The APIs can be but are not limited to SQL, NoSQL, NewSQL, ODBC, JDBC, etc.

The analysis system 110 may be used by content providers 150 in an effort to quantify the impact (e.g., input, response) of content items. The analysis system 110 can include one or more processors (e.g., any general purpose or special purpose processor), and can include and/or be operably coupled to one or more transitory and/or non-transitory storage mediums and/or memory devices (e.g., any computer-readable storage media, such as a magnetic storage, optical storage, flash storage, RAM, etc.). In various implementations, the analysis system 110 and the content management system 170 can be implemented as separate systems or integrated within a single system (e.g., the content management system 170 can be configured to incorporate some or all of the functions/capabilities of the analysis system 110). The analysis system 110 may be configured to communicate over network 130 via a variety of architectures (e.g., client/server, peer-to-peer, etc.). The analysis system 110 can be configured to provide a variety of interfaces for analyzing attribution credits, monitoring product responses, and performing pingback corrections.

The analysis system 110 can be communicably and operatively coupled to the analysis database 120 which may be configured to store a variety of information relevant to determining relatedness and attribution credits performed by analysis system 110. Information may be received from user devices 140, content provider devices 150, data sources 160, and/or content management system 170, for example. The analysis system 110 can be configured to query the analysis database 120 for information and store information in the analysis database 120. In various implementations, the analysis database 120 includes various transitory and/or non-transitory storage mediums. The storage mediums may include but are not limited to magnetic storage, optical storage, flash storage, RAM, etc. The analysis database 120 and/or the analysis system 110 can use various APIs to perform database functions (i.e., managing data stored in the analysis database 120). The APIs can be but are not limited to SQL, NoSQL, NewSQL, ODBC, JDBC, etc.

In some implementations, third-party systems 180 can transmit responses of products and provide information about the responses and/or products (e.g., interaction data) which may be stored in analysis database 120 (e.g., interaction dataset 122). In addition, analysis system 110 may be configured to retrieve data via network 130 (e.g., user activity data, content campaign data, etc.) which may be stored in the interaction dataset 122 of analysis database 120. In various implementations, interaction dataset 122 can include interactions, such as but not limited to, last click, last view, playthrough, historical data, etc., product response information, content item information, such as but not limited to, associated products, placement, arrangement, timing information, etc., product identifiers, purchase information, such as but not limited to, customer financial information, purchase price, discounts, etc., user information, such as but not limited to, browser information, user device data, operating system, historical information, user identifiers, etc., third-party information, content provider information, virtual assistant information, such as but not limited to, questions, user voice data, settings, notifications, etc.

Analysis system 110 can be configured to communicate with any device or system shown in environment 100 via network 130. The analysis system 110 can be configured to receive information from the network 130. The information may include browsing histories, cookie logs, television content data, printed publication content data, radio content data, and/or online content activity data. The analysis system 110 can also be configured to receive and/or collect the interactions that the user devices 140 have on the network 130. This information may be stored as content data in interaction dataset 122.

Data sources 160 may include data collected by the analysis system 110 by receiving interaction data from the content provider devices 150, user devices 140, and/or third-party systems 180. The data may be content input (e.g., content spend), content response (e.g., content revenue) for particular media channels (e.g., television, Internet content, radio, billboards, printed publications) at one or more points in time, product response (e.g., product purchases). The content input may include spending on television content, billboard content, Internet content (e.g., search content spend, or display content spend, etc.). The data may be data input for particular entities or users (e.g., patients, customer purchases, internet content items) at one or more points in time. The content input may include data associated with a plurality of entities, a plurality of users, a specific entity, a specific user, etc. Data sources 160 may also include various data aggregating systems and/or entities that collect content data. The analysis system 110 can receive product response data from the data sources 160 via the network 130. This information may be stored as product response data in interaction dataset 122.

The analysis system 110 can be configured to send information and/or notifications relating to various metrics (e.g., predictions) or models it determines, generates, or fits to the content provider devices 150. This may allow a user of one of the content provider devices 150 to review the various metrics or models which the analysis system 110 determines. Further, the analysis system 110 can use the various metrics to identify opportune times to make contact with a user or appropriate amounts (e.g., an optimal mixed media input) to input on various media channels (e.g., television advertising, Internet advertising, radio advertising, etc.). The analysis system 110 can cause a message to be sent to the content management system 170 and/or the content provider devices 150 indicating that the content management system 170 should make contact with a certain user at a certain time and/or a content campaign operator with certain parameters.

The analysis system 110 may include one or more systems (i.e., computer-readable instructions executable by a processor) and/or circuits (i.e., ASICs, Processor Memory combinations, logic circuits, etc.) configured to perform various functions of the analysis system 110. In some implementations, the systems may be or include a crediting system 112, a pingback system 114, a modeler 116, and a data manager 118. It should be understood that various implementations may include more, fewer, or different systems than illustrated in FIG. 1, and all such modifications are contemplated within the scope of the present disclosure.

The data manager 118 can be configured to generate various data structures stored in the analysis database 120. For example, the data manager 118 can be configured to generate relatedness graphs. In some implementations, the relatedness graphs can be represented by a series of vectors between nodes each with their own weight of relatedness (sometimes referred to herein as a “relatedness index”). For example, one node may be a pair of headphones associated with Company X, another node may be a phone associated with Company X, and yet another node may be a smart speaker associated with Company Y. In particular, the relatedness graph may be a data structure included in the relatedness dataset 124 and indicate various relationships between items and/or products of one or more third-parties. For example, a relatedness graph could include a plurality of products associated with a plurality of third-parties that can include relatedness indexes between various nodes (e.g., items and/or products) within the relatedness graph. The relatedness graph can be generated by the data manager 118 determining relatedness between one or more items and/or products based on receiving and collecting data from a plurality of sources. In various implementations, the plurality of sources can include, but not limited to, data sources 160 (e.g., n-grams (sometimes referred to as “Ngrams”) based on product descriptions, n-grams based on third-party (or merchandiser) descriptions, n-grams based on reviews, articles, and other gathered public/private data, financial institutions), user devices 140 (e.g., user customization, user co-response behavior, purchase history), content provider devices 150, third-party systems 180, etc. In some implementations, the data manager 118 may, in real-time, continuously update the relatedness graphs based on receiving and collecting data from the plurality of sources. Furthermore, new and/or additional sources (e.g., new n-gram data, additional user data, additional interaction data) of data may be utilized on a continual basis (e.g., autonomously, after scanning for new/additional sources) to update the relatedness graphs (e.g., update relatedness index, add new product and determine relatedness to other products in the relatedness graph, etc.).

The data manager 118 can also be configured to receive a plurality of product responses from a plurality of user devices 140, content provider devices 150, data sources 160, and/or third-party systems 180. For example, upon a completion of a purchase (e.g., product response) by a customer on Seller J's online store (e.g., third-party system 180), the data manager 118 may receive a product response including interaction data indicating a user interaction with a content item of a particular product. In another example, upon initiation of a service (e.g., streaming service, investment service, tutorial service, etc.) by a customer of Service Provider K (e.g., 180), the data manager 118 may receive a product response including interaction data indicating a user interaction with a content item of a particular service. In yet another example, upon a completion of a transaction by a customer at Company L in-person, the data manager 118 may receive a product response including interaction data indicating a transaction. However, in the following example, the data manager 118 may infer the content item the user interacted with based on various other interaction data (e.g., user device data, financial information, content provider information, etc.).

The data manager 118 can be configured to receive interaction data (e.g., stored in interaction dataset 122). In some embodiments, the data manager 118 can be configured to receive interaction data from a plurality of responses from a third-party system 180, user devices 140, and/or content provider devices 150 instead of data specific to a particular customer. Furthermore, to protect particular customer information, the interaction data may be stripped and/or anonymized, by the data manager 118, to remove identifying information of customers. In various embodiments, the received data that the data manager 118 receives can be data that analysis system 110 aggregates and/or data that the analysis system 110 receives from the data sources 160.

The data manager 118 can also be configured to communicate with content management system 170 via network 130 in order to determine a set of one or more content items associated with a content provider to be analyzed after receiving a product response. In addition, data manager 118 may be configured to determine one or more characteristics associated with the one or more content items. Characteristics may include associated keywords used in a search query, website views, video views (e.g., via YouTube), content views, content clicks, mobile application views (e.g., via Google Chrome, Google Maps, Gmail), etc. For example, data manager 118 may be configured to determine (e.g., via a campaign ID or other identifier) content items associated with a content campaign for a new restaurant. In this example, data manager 118 may also determine that the set of content items is presented based on a set of target keywords (e.g., restaurant, new restaurant, restaurant in geographic location, etc.). Data manager 118 may also be configured to initiate a change in input level associated with a set of content items based on modeler 116 analyzing the product responses.

The data manager 118 can further be configured to retrieve and analyze user interaction data including actions performed by user devices 140 over network 130. In some implementations, data manager 118 retrieves interaction data and creates an activity log with one or more log entries. The activity log can span over any specified time period (e.g., past month, past week, etc.) and can be specific to users based on any constraints (e.g., users in Los Angeles, Android users in Boston, users with a product response of a pair of Headphones, etc.). The data manager 118 may be configured to use a filtered activity log in order to determine a subset of users (i.e., a subset of the users associated with the original activity log). The subset of users may be users that have a likelihood of being exposed to the content items being analyzed. In addition, data manager 118 may be configured to retrieve user activity data related to a response metric (e.g., product responses).

The interaction dataset 122 may include subsets of data that each include response data, content input data (e.g., input data), a content type, control variables, and/or a provider identifier associated with the content item. The data may be for one or more points in time over an interval (e.g., data for each hour out of a day, data for each day out of a year, data for each month out of a decade, etc.). The content type may indicate a particular media channel of the set of data, for example, television, radio, Internet content, newspaper or magazine content, etc. The response data can be a result of an action associated with the input data. That is, the response data may indicate particular amounts of revenue at particular times (e.g., of one or more products). In some embodiments, the response is one or more conversions, one or more sales, one or more purchases, one or more account registrations, one or more subscriptions, one or more product activations, etc. The input data may indicate particular amounts (e.g., fiat currency) of content input for the content type at particular times. The input data may further indicate a number of content runs. The interaction dataset 122 may include time series data structures indicating amounts of input data, response data, for various media channels and/or various geographic regions over time.

The modeler 116 may be configured to determine related product responses and full product responses based on an attribution model. In general, the attribution model can be configured to determine relatedness of products of a product response based on aggregating weights of measures of degrees between a first node (e.g., product A associated with product response) and a second node (e.g., product B associated with a content item) and normalizing the aggregated weights to generate a relatedness index. As described above, the data manager 118 can be configured to maintain the relatedness graph stored in relatedness dataset 124. The modeler 116 can utilize the relatedness graph to then determine how related one product is to another such that a relatedness can be calculated, and a potential attribution credit can be awarded (e.g., by crediting system 112). In some embodiments, the attribution model may be a trained model stored in the analysis database 120 and can provide output predictions (e.g., relatedness indexes) based on inputted variables (e.g., products of product responses). Furthermore, the attribution model can quantify the relatedness of a particular product responses to a content item presented to a user (e.g., across media channels). This causal approach allows attribution models to provide significant improvements to predictions of product responses relatedness such that the accuracy of the prediction of attribution models and the allocation of attribution credit is improved and as a result, enabling content providers to make informed decisions about their initiatives. In some implementations, the input data, response data may be inferred utilizing one or more machine learning algorithms (e.g., a neural network, convolutional neural network, recurrent neural network, linear regression model, sparse vector machine, or any other algorithm known to a person of ordinary skill in the art).

The modeler 116 also can be configured to identify trends in product responses based on analyzing the interaction data and historical interaction data of previous product responses. That is, each product response and associated attribution credit can be compared, historical product responses can be tracked, and trends (or patterns) over time can be established. Trending and pattern recognition operations can be executed to identify trends and/or patterns in various product responses. In particular, based on evaluating product responses and/or other interaction data in interaction dataset 122, one or more processing circuits of the modeler 116 can identify trends and/or patterns (e.g., linear, exponential, seasonality, random, damped window, stationary, AI, and/or cyclical trends and/or patterns) of the various products, content items, and/or product responses. In some embodiments, the relatedness graph can be updated by the data manager 118 based on identifying a trend in product responses. That is, in response to analyzing historical product responses and/or a receival of a product response, the content management system 170 can be notified to update a content item slot of a content item (e.g., website content item slot, video content item slot, mobile application content item slot, etc.). For example, a plurality of users may have recently responded (e.g., purchased) a newly released television model. In the following example, the modeler 116 may determine a trend indicating that the newly released television model is being purchased more than the previously released television model and may provide an indication to the content management system 170 to update the content item slot with a content item associated with the newly released television model. In some implementations, the modeler 116 can directly update the content item slot based on retrieving (from content items 174) or generating a content item for presentation. Furthermore, the data manager 118 may also update the relatedness graph including the newly released television model and/or update the weights between the previously released television model node and the other nodes in the relatedness graph (e.g., decreasing relatedness, removing edges, etc.).

Using the relatedness graph, modeler 116 may attribute one or more product responses of a first product to a content item in a content campaign associated with a second product that may be related. Furthermore, the modeler may also attribute one or more product responses of a first product and a second product to a content item in a content campaign associated with the second product to capture the full product response. In some embodiments, modeler 116 may also attribute a response to a related product for which the modeler 116 otherwise does not have response metrics for. In some implementations, modeler 116 may combine relatedness graphs to determine a combined relatedness index. For example, for a particular content item displayed on different resources, a relatedness index may be determined based on a combination of interactions associated with a plurality of content items and the attribution credit may be divided (e.g., equally, weighted, etc.) based on the number of combination of interactions. Furthermore, as described above in more detail, modeler 116 may be used to adjust a content campaign of the content provider. For example, based on the relatedness index, a cost per action metric may be adjusted for a content item in the content campaign. The cost per action metric is generally representative of a cost for the content provider in order to attain a response (or conversion). By adjusting the cost per action metric, the content provider may choose to pay more or less for providing the content item for display on a resource, thereby adjusting the parameters of the content campaign of the content provider. In other words, the content provider (e.g., 150) may adjust its strategy for providing various content items in a content campaign, based on a more accurate representation of the performance of product responses.

In another example, a plurality of users may have not responded to a smart phone for an extended period of time (e.g., 7 days, 1 month, etc.). In the following example, the modeler 116 may determine a trend indicating that the smart phone is obsolete, and the content item slot may be updated (e.g., by modeler 116 and/or content management system 170) and the relatedness graph may be updated (e.g., by data manager 118). In yet another example, a plurality of users may have responded to a content item associated with a dryer but purchase a washer. In the following example, the modeler 116 may determine the washer is being purchased more than the dryer and the content item in the content item slot may be updated to include the washer, and the relatedness graph may be updated (e.g., modifying weights, adding a node, etc.).

The crediting system 112 can be configured to calculate an attribution credit for each of the plurality of product responses based on the generated relatedness index by modeler 116. In other words, the crediting system 112 can be configured to credit related responses and full product responses (e.g., whole cart value) such that an accurate credit can be provided to the content provider (e.g., 150). In some embodiments, the attribution credit may be calculated differently based on the relatedness index (e.g., more related may equal a higher credit, whereas less related may equal a lower credit). In particular, the calculation can utilize various mathematical operations (e.g., algebra, calculus, Boolean algebra) configured by one or more systems described herein such that the attribution credit may be unique to a particular entity, user, and/or content provider. For example, entity X may have a higher threshold (e.g., relatedness greater than 0.70) and utilize equation X (e.g., Relatedness Index×(100÷edges)=attribution credit) to calculate the attribution credit, whereas entity Y may have a lower threshold (e.g., relatedness greater than 0.50) and utilize equation Y (e.g., Relatedness Index×100(if relatedness index>0.90), Relatedness Index×75((if relatedness index>0.80), or Relatedness Index×50(if relatedness index<0.80)=attribution credit) to calculate the attribution credit. As shown, each attribution credit calculation may be unique such that the crediting system 112 may utilize different calculations based on the entity, user, and/or content provider.

The pingback system 114 can be configured to receive pingback corrections from user devices 140, content provider devices 150, and/or third-party systems 180, all over network 130. The pingback correction can include remitted product responses based on a remittance (e.g., returned, refunded, replaced, recall, etc.) of a product. In some embodiments, after an attribution credit is allocated to a content provider device 150, the pingback system 114 can establish a communication channel with the user devices 140, the content provider devices 150, data sources 160, and/or third-party system 180 (e.g., including card provider entities such as financial institutions and/or credit card entities) to receive the pingback corrections. The established communication channel can be over network 130 and may be established for a specific time (e.g., 30 days, 3 months, 3 years, etc.). The facilitation of communication can be implemented as an application programming interface (API) (e.g., REST API, Web API, customized API), batch files, and/or queries. In various arrangements, the pingback system 114 can also be configured to control access to resources of the user devices 140, the content provider devices 150, data sources 160, and/or third-party system 180. Furthermore, a pingback correction can be received by pingback system 114 over network 130 via the API and the pingback system 114 can update the attribution credit assigned associated with the product response of the product remitted. In various embodiments, the updated attribution credit may revalue the attribution credit as if the product was not responded to. In some embodiments, the data manager 118 may also update the interaction dataset 122 (e.g., historical data) and relatedness dataset 124 (e.g., relatedness graph) based on the pingback correction. For example, an attribution credit may be decreased since the impact of the content item responded to with one or more of the products may not have been as impactful. Furthermore, the modeler 116 may re-train the attribution model stored in analysis database 120 based on the pingback correction.

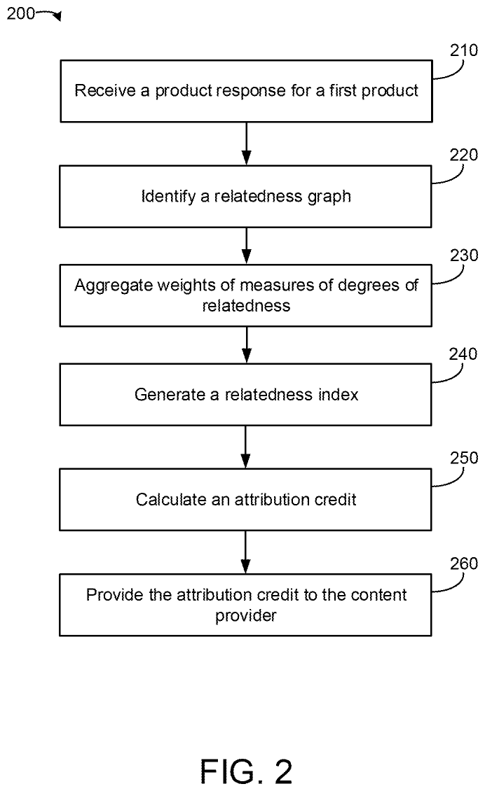

Referring now to FIG. 2, a flowchart for a method 200 of determining related product responses, according to an illustrative implementation. The analysis system 110 and associated environment 100 can be configured to perform method 200. Furthermore, any computing device described herein can be configured to perform method 200.

In broad overview of the method 200, at block 210, the one or more processing circuits can receive a product response for a first product. At block 220, the one or more processing circuits can identify a relatedness graph. At block 230, the one or more processing circuits can aggregate weights of measures of degrees of relatedness. At block 240, the one or more processing circuits can generate a relatedness index. At block 250, the one or more processing circuits can calculate an attribution credit. At block 260, the one or more processing circuits can provide the attribution credit to the content provider. Additional, fewer, or different operations may be performed depending on the particular arrangement. In some arrangements, some or all operations of method 200 may be performed by one or more processors executing on one or more computing devices, systems, or servers. In various arrangements, each operation may be re-ordered, added, removed, or repeated.

Referring to method 200 in more detail, at block 210, the one or more processing circuits can receive a product response (e.g., an event) for a first product, the product response including interaction data indicating a user interaction with a content item of a second product, wherein the content item is associated with a content provider. In some embodiments, the product response may be received by the data manager 118 over network 130 from a third-party system (e.g., third-party systems 180). For example, upon purchase of an HDMI cable from a third-party system, the third-party system (e.g., website, in-store, mobile application, phone call, etc.) may provide the interaction data (e.g., purchase information, user information, content item information) to data manager 118. In various embodiments, the interaction data may be associated with the product response (or event) which may be indicative of a purchase of a product and/or service. The purchase can be linked to a content item based on information collected during the shopping experience (e.g., click a content item, playthrough information, last click, search information, etc.). In particular, the content item be an advertisement in a content item slot associated with a second product (e.g., smart television).

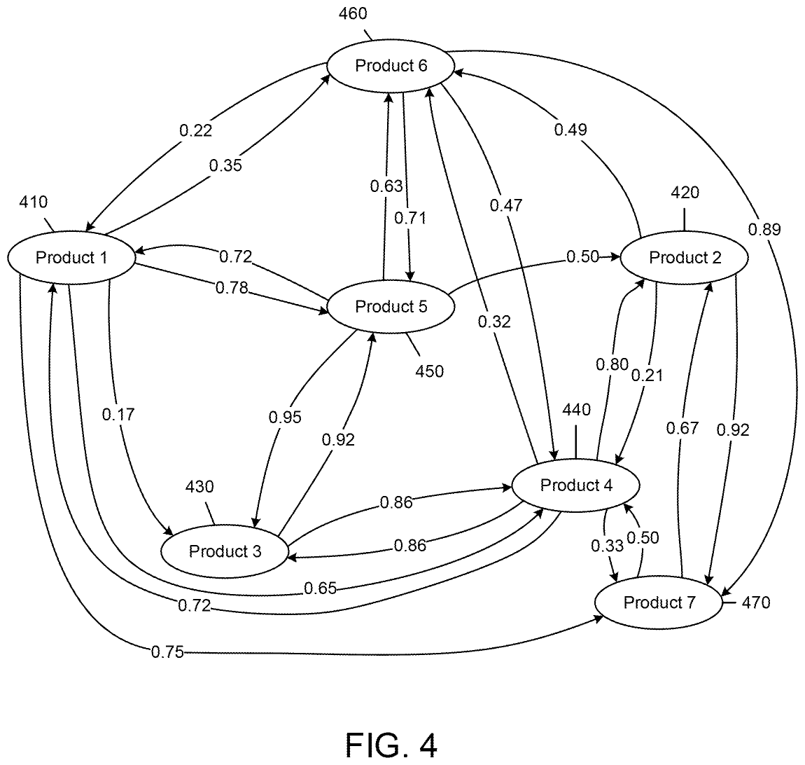

At block 220, the one or more processing circuits can identify a relatedness graph of a plurality of products. In various embodiments, a relatedness graph may be stored in relatedness dataset 124 and can be generated and/or updated by the data manager 118 based on receiving additional interaction data and analyzing the interaction dataset 122. In particular, the generation and updating of relatedness graphs can include modifying a weight of a measure of degree between two nodes. Each node (e.g., associated with a product of a plurality of products) in the relatedness graph may be related to one or more nodes based on weights of measures of degrees. Additional details regarding the relatedness graph are described in detail with reference to FIG. 4. Furthermore, a plurality of relatedness graphs may be stored in relatedness dataset 124 and each graph may be associated with, but not limited to, a particular entity (e.g., Company A), a group of entities (e.g., Company A and Company B), a type of entity (e.g., hardware, technology, big box, etc.), a type of product (e.g., phones, televisions, clothing, etc.), and/or by any characteristic of the plurality of products.

At blocks 230 and 240, the one or more processing circuits can aggregate weights of measures of degrees of relatedness in the relatedness graph of a first node of the first product to a second node of the second product, and generate a relatedness index based on normalizing the aggregation of the weights of the measures of degrees. In some embodiments, the path between the first node and the second node is determined based on the modeler 116 traversing the entire relatedness graph starting at the first node associated with the first product. The traversal of the entire relatedness graph can be based on a traversal algorithm (e.g., breadth-first search (BFS), depth-first search (DFS)) that can determine the optimal path between the first product (e.g., first node) and second product (e.g., second node), where the optimal path is the path with the lowest aggregate weights of measures of degrees of relatedness. For example, after a traversal, the weights of measures of degrees of relatedness between the first product (node 1) and the second product (node 4), may be (Table 1):

| | Traversal Path (Node) | Weights | Aggregate Weights |
|---|---|---|---|
| 1 | 1, 3, 7, 8, 4 | 0.71, 0.75, 0.23, 0.93 | 2.62 |
| 2 | 1, 5, 6, 4 | 0.19, 0.56, 0.78 | 1.53 |
| 3 | 1, 9, 4 | 0.82, 0.56 | 1.38 |

In some embodiments, the modeler 116 can aggregate the weights of measures of degrees of relatedness and normalize the traversal path weights. The normalization can modify the aggregate weights in their natural range to a standard range (e.g., 0 to 1.0). For example, the modeler 116 can normalize the traversal path weights based on the number of edges traversed (Table 2):

| | Traversal Path (Node) | Edges | Normalized (Relatedness Index) |
|---|---|---|---|
| 1 | 1, 3, 7, 8, 4 | 4 | 2.62/4 = 0.655 |
| 2 | 1, 5, 6, 4 | 3 | 1.53/3 = 0.51 |
| 3 | 1, 9, 4 | 2 | 1.38/2 = 0.69 |

As shown above, the relatedness index for path 1 could be 0.655, for path 2 could be 0.51, and for path 3 could be 0.69. Further, the modeler 116 can select the highest relatedness index of the plurality of relatedness index. However, in some implementations, the modeler 116 may select a different relatedness index (e.g., closest to a value, lowest relatedness index, fewest edges traversed, etc.) based on, but not limited to, a user customization, a content provider customization, and/or a third-party customization, or a modeler 116 determination based on historical data. In some embodiments, normalizing can be performed utilizing various normalization techniques such as, but not limited to, linear scaling, log scaling, clipping, z-scoring. In various embodiments, the modeler 116 may traverse a plurality of relatedness graphs associated with the first product and the second product. For example, relatedness graph A may be associated with a particular entity that sells the first and second product, whereas relatedness graph B may be associated with a plurality of entities that sell the first and second product. In the following example, the modeler 116 may traverse the graph in each of the relatedness graphs and select the relatedness index with the largest relatedness (e.g., closest to 1.0). In some embodiments, one relatedness graph may be weighted over another relatedness graph such that one relatedness graph may be favored and/or more accurate than another relatedness graph. In particular, some relatedness graphs may be built with more information (e.g., with more accurate weights) than another relatedness graph and the modeler 116 may weight relatedness graphs accordingly. For example, relatedness graph A may be weighted such that each relatedness index may be a 1-to-1 ratio of the weight (e.g., calculated relatedness index equaling 0.94 would be weighted and would equal 0.94), but relatedness graph B may be weighted as 1-to-½ of the weight (e.g., calculated relatedness index equaling 0.94 would be weighted and would equal 0.94/2, or 0.47).

At blocks 250 and 260, the one or more processing circuits can, in response to the relatedness index exceeding a threshold, calculate an attribution credit assigned to the product response based on the relatedness index and provide the attribution credit to the content provider of the content item. In some embodiments, the threshold may be based at least one of a first sensitivity set by an entity, a second sensitivity set by the content provider, the content item, the first product, or the second product. That is, the threshold can be a sensitivity based on one or more factors and if the relatedness index exceeds the threshold then an attribution credit can be calculated to attribute a related product response to a content item of a content provider. For example, a user may purchase a pair of headphones after interacting with (e.g., viewing, selecting) a content item for a new phone. In the following example, instead of purchasing the phone after being redirected to the third-parties website and/or mobile application (e.g., Google Shopping, Google Play), the user (sometimes referred to herein as “customer”) may purchase a pair of headphones. In this example, the relatedness index may be above the threshold (e.g., 0.75 >0.5 (threshold)) and the attribution credit can be calculated and provided to the content provider. In some embodiments, the attribution credit can be normalized between two values (e.g., 0-1, 0-10, 0-100), and can be weighted based on the relatedness index. For example, the attribution credit may be calculated based the response (e.g., $100, $2,500) and the relatedness index (e.g., 0.76, 0.32). For example, a related product response of $100 may be credited at $100×0.76=76 attribution credits and a related product response of $2,500 may be credited at $2,500×0.32=800 attribution credits. In another example, a full product response of $100 (e.g., more than one product) may be credited at $100+0.76=131.58 attribution credits (or $100+(100*0.76)=176 attribution credits and a related product response of $2,500 may be credited at as 2500 attribution credits because the relatedness index was not above the threshold. As shown in the following examples, various calculation (e.g., operations and/or algebra (e.g., addition, subtraction, multiplication, division, squaring, summations), calculus (e.g., derivations), computational logic (e.g., Boolean algebra). In some embodiments, the analysis system 100, user devices 140, content provider devices 150, and/or any other systems described herein may be configured to set parameters, configurations, and/or preferences for calculating attribution credits.

In some embodiments, methods 200 and 300 can also include the one or more processing circuits receiving a pingback correction indicating the product response was remitted (e.g., returned) from an entity computing system associated with the first product. Further, the one or more processing circuits can update the attribution credit reflecting the remitted product response and providing the updated attribution credit to the content provider. That is, if a product response is remitted the one or more processing circuits can correct the previously calculated attribution credit, such that the attribution credit can be attributed based on the products responded too, excluding the remitted products.

Using the relatedness graph and relatedness index in this way allows the attribution credit for a content item related to one product to be awarded based on a product response (e.g. a purchase) for a different product in an easy and computationally efficient way. In particular, it allows the relationship between many products to be recorded with a measure of their relatedness in a way which can be quickly and easily investigated by computationally traversing a graph. This helps provide attribution credit accurately and rapidly for a large number of products with complex relationships to each other.

In various embodiments, methods 200 and 300 can also include identifying trends and/or patterns (e.g., increased product response for one or more products, increased bundled product responses (e.g., multi-product, or full product), decrease in product response of one or more products, updates to content item slots, increased content input, recent news (e.g., articles, world health organization (WHO) reports, pandemic guidance, natural disasters, events (e.g., sporting, music)), software updates, virtual assistant information (e.g., questions asked, commands by the user), search queries, user clicks, geolocation of one or more users, etc.) in product responses based on analyzing the interaction data and historical interaction data of previous product responses (e.g., stored in interaction dataset 122). In particular, in response to identifying trends the one or more processing circuits can determine a different content item associated with the first product and modify a content item slot of the content item with the different content item. Alternatively or additionally, in response to identifying trends the one or more processing circuits can calculate new weights of the measures of degrees between the first node and the second node and update the relatedness graph with the new weights of the measures of degrees between the first node and the second node. Therefore, the attribution model described herein can continuously update and modify the relatedness graphs and content item slots based on identifying trends.

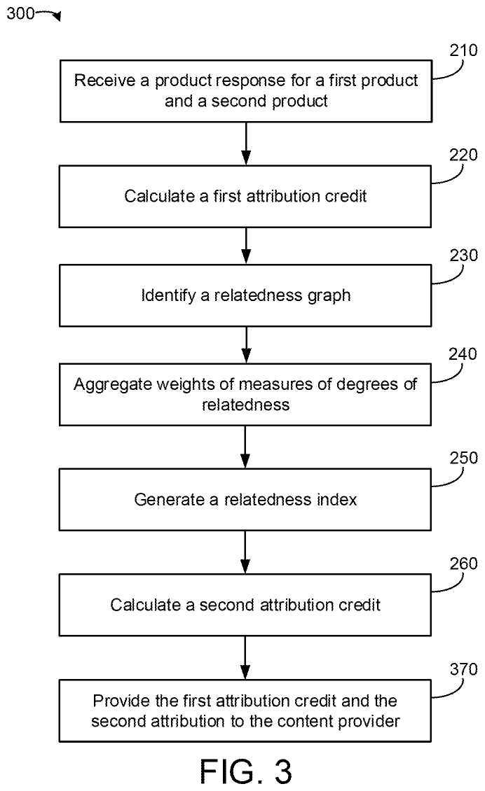

Referring now to FIG. 3, a flowchart for a method 300 of determining full product responses, according to an illustrative implementation. The analysis system 110 and associated environment 100 can be configured to perform method 300. Furthermore, any computing device described herein can be configured to perform method 300.

In broad overview of the method 300, at block 310, the one or more processing circuits can receive a product response for a first product and a second product. At block 320, the one or more processing circuits can calculate a first attribution credit. At block 330, the one or more processing circuits can identify a relatedness graph. At block 340, aggregate weights of measures of degrees of relatedness. At block 350, the one or more processing circuits can generate a relatedness index. At block 360, the one or more processing circuits can calculate a second attribution credit. At block 370, the one or more processing circuits can provide the first attribution credit and the second attribution to the content provider. Additional, fewer, or different operations may be performed depending on the particular arrangement. In some arrangements, some or all operations of method 300 may be performed by one or more processors executing on one or more computing devices, systems, or servers. In various arrangements, each operation may be re-ordered, added, removed, or repeated.

Referring to method 300 in more detail, at block 310, the one or more processing circuits can receive a product response for a first product and a second product, the product response including interaction data indicating a user interaction with a content item of the second product, wherein the content item is associated with a content provider. In some embodiments, the product response may be received by the data manager 118 over network 130 from a third-party system (e.g., third-party systems 180). For example, upon purchase of a dishwasher and a warranty from a third-party system (e.g., website, in-store, mobile application), the third-party system may provide the interaction data (e.g., purchase information, user information, content item information) to data manager 118. In various embodiments, the interaction data may be associated with the product response (or event) may be indicative of one or more purchases of a plurality of products and/or services. The purchase can be linked to a content item based on information collected during the shopping experience (e.g., activity data). In particular, the content item be an advertisement in a content item slot associated with a second product (e.g., dishwasher).

In some embodiments, at block 310, the one or more processing circuits can receive a plurality of product responses over a period time related to at least a first product and a second product. The plurality of product responses can include a plurality of interaction data and the one or more processing circuits can correlate the plurality of responses as a bundle based on similar interaction data. For example, a user may purchase a phone on Mar. 14, 2021 from Company X and a charging cable from Company X on Mar. 15, 2021. In the following example, interaction data may be received by the one or more processing circuits (e.g., analysis system 110) from both responses (e.g., purchases) and they may be bundled based on the financial information used in the responses (e.g., interaction data). In another example, the user may purchase the phone on Mar. 14, 2021 in store at Company Y and purchase a cloud service on Mar. 16, 2021 online via Company Z's website, Company Z's mobile application, and/or a smart assistant (e.g., Google Assistant, smart speaker, etc.). In the following example, interaction data may be received by the one or more processing circuits from both responses and they may be bundled based on the user having viewed a content item from their user device (e.g., interaction data). As shown below, the second attribution credit may account for the phone and the cloud service as a full product response. Furthermore, at block 310, the one or more product responses may include a plurality of products (e.g., 20 products in one response, 10 products across three responses) and the one or more processing circuits may execute the following blocks (320-370) on each of the plurality of products and/or as a bundle of products.

At block 320, the one or more processing circuits can calculate a first attribution credit assigned to the product response. In various embodiments, the first attribution credit can be based on the product response of the second product (e.g., dishwasher) of the plurality of products in the product response. As shown, the first attribution credit may be undervaluing (e.g., attributing the dishwasher purchase), overvaluing (e.g., attributing the entire purchase price to one product), or unvaluing (e.g., not attributing the warranty purchase) the entirety of the product response (e.g., more than one product and/or service purchased). In some embodiments, the analysis system 110 (e.g., crediting system 112) may skip calculating the first attribution credit.

At blocks 330, 340, and 350, the one or more processing circuits can identify a relatedness graph of a plurality of products, aggregate weights of measures of degrees of relatedness in the relatedness graph of a first node of the first product to a second node of the second product, and generate a relatedness index based on normalizing the aggregation of the weights of the measures of degrees. Blocks 330-350 resemble similar features and functionality described above in detail with reference to FIG. 2, blocks 220-240.

At blocks 360 and 370, the one or more processing circuits can, in response to the relatedness index exceeding a threshold, calculate a second attribution credit assigned to a full product response based on the relatedness index and provide the first attribution credit and second attribution credit to the content provider of the content item. Blocks 360-370 resemble similar features and functionality described above in detail with reference to FIG. 2, blocks 250-260. However, as shown, the second attribution credit can be assigned to the full product response (e.g., dishwasher and warranty) instead of assigning the attribution credit to the content item that was interacted with by the user (e.g., first attribution credit). In some embodiments, the second attribution credit can be an accurate attribution credit without undervaluing, overvaluing, or unvaluing a response. As shown, the attribution models can provide enhanced performance and efficiency while reducing the amount of unvalued responses. As shown, using the attribution model, the one or more processing circuits can determine full product responses and attribute credit accordingly without undervaluing, overvaluing, or unvaluing a product response of a plurality of products related to a product in a content item. For example, if a user interacts with a content item associated with a laptop but the responses also includes a laptop mouse and docking station, the attribution credit can be valued such that the additional products purchased (or the full product response) can be credited accurately (e.g., increasing the attribution credit). In another example, if a user interacts with a content item associated with a laptop but the responses also includes vegetable seeds for gardening, the attribution credit can be valued such that the additional products purchased (or the full product response) can be credited accurately (e.g., the vegetable seeds relatedness index may not reach the threshold for relatedness to modify the attribution credit). However, in the following example, if users continuously purchase vegetable seeds with a purchase of the laptop, the modeler 116 may update the content item in the content item slot to include vegetable seeds on the screen of the laptop as an example user interface displayed on the laptop.

Referring now to FIG. 4, an example representation of a relatedness graph, according to an illustrative implementation. In some implementations, a relatedness graph can include a plurality of nodes (e.g., 410, 420, 430, 440, 450, 460, 470) with a plurality of weighted vectors (or measures of degrees). For example, Product 1 (e.g., 410) may include a relatedness vector to Product 4 (e.g., 440) with a relatedness vector of 0.65, Product 5 (e.g., 450) with a relatedness vector of 0.78, Product 6 (e.g., 460) with a relatedness vector of 0.35, and Product 7 (e.g., 470) with a relatedness vector of 0.75. As shown, Product 1 may not have a vector to Product 2 (e.g., 420) but the modeler 116 utilizing the attribution model can aggregate multiple vectors (e.g., Product 1 vector to Product 5, and Product 5 vector to Product 2) and normalizing the aggregate to get a relatedness index. Furthermore in some embodiments, the relatedness vectors may have different relatedness indexes based on the direction (e.g., relatedness index from 440 to 420 is 0.80, whereas relatedness index of 420 to 440 is 0.21). In this example shown, each node could be a product, a service, or a combination of, associated with one or more entities, and the relatedness vectors can be indicative of a relatedness index. Thus, in this particular example, the relatedness graph can provide insight into a product/product, product/service, and/or service/service relationship. One insight could include a particular relatedness of a first product (e.g., 410) to a second product (e.g., 440).

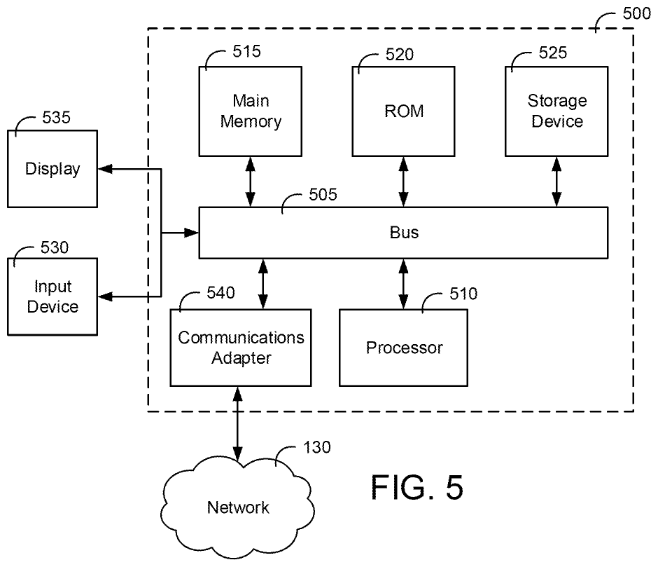

FIG. 5 illustrates a depiction of a computer system 500 that can be used, for example, to implement an illustrative user device 140, an illustrative content provider device 150, an illustrative analysis system 110, and/or various other illustrative systems described in the present disclosure. The computing system 500 includes a bus 505 or other communication component for communicating information and a processor 510 coupled to the bus 505 for processing information. The computing system 500 also includes main memory 515, such as a random-access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 520 or other static storage device coupled to the bus 505 for storing static information and instructions for the processor 510. A storage device 525, such as a solid-state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information, and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

In some implementations, the computing system 500 may include a communications adapter 540, such as a networking adapter. Communications adapter 540 may be coupled to bus 505 and may be configured to enable communications with a computing or communications network 130 and/or other computing systems. In various illustrative implementations, any type of networking configuration may be achieved using communications adapter 540, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. In alternative implementations, hard-wired circuitry may be used in place of or in combination with software instructions to implement illustrative implementations. Thus, implementations are not limited to any specific combination of hardware circuitry and software.

Although an example processing system has been described in FIG. 5, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer-readable storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks, distributed ledger networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TELEVISION channel, on a satellite TELEVISION channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, Disney+, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a smart watch, a tablet PC, or other computing device.

While this specification contains many specific implementation details, these should not be construed as limitations on the scope of any disclosures or of what may be claimed, but rather as descriptions of features specific to particular implementations of particular disclosures. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method for determining related product responses, the method comprising:
receiving, by one or more processing circuits, a product response for a first product, the product response comprising interaction data indicating a user interaction with a content item of a second product, wherein the content item is associated with a content provider;
identifying, by the one or more processing circuits, a relatedness graph of a plurality of products;
aggregating, by the one or more processing circuits, weights of measures of degrees of relatedness in the relatedness graph of a first node of the first product to a second node of the second product;
generating, by the one or more processing circuits, a relatedness index based on normalizing the aggregation of the weights of the measures of degrees;
in response to the relatedness index exceeding a threshold, calculating, by the one or more processing circuits, an attribution credit assigned to the product response based on the relatedness index; and
providing, by the one or more processing circuits, the attribution credit to the content provider of the content item.

2. The method of claim 1, further comprising:
receiving, by the one or more processing circuits, a pingback correction indicating the product response was remitted from an entity computing system associated with the first product;
updating, by the one or more processing circuits, the attribution credit reflecting the remitted product response; and
providing, by the one or more processing circuits, the updated attribution credit to the content provider.

3. The method of claim 1, further comprising:
identifying, by the one or more processing circuits, a trend in the product response based on analyzing the interaction data and historical interaction data of previous product responses.

4. The method of claim 3, further comprising:
in response to identifying the trend, determining, by the one or more processing circuits, a different content item associated with the first product; and
modifying, by the one or more processing circuits, a content item slot of the content item with the different content item.

5. The method of claim 3, further comprising:
in response to identifying the trend, calculating, by the one or more processing circuits, new weights of the measures of degrees between the first node and the second node; and
updating, by the one or more processing circuits, the relatedness graph with the new weights of the measures of degrees between the first node and the second node.

6. The method of claim 1, wherein the relatedness graph comprises a plurality of nodes including the first node and the second node, and wherein each node of the plurality of nodes is associated with a product of the plurality of products.

7. The method of claim 6, wherein each measure of degree of the measures of degrees connecting the plurality of nodes of the relatedness graph are weighted based on relationships between the plurality of products, wherein the relationships are at least one of an entity explicit designation of a relative weighting between the relationships, product identifiers, one or more taxonomies, one or more n-gram sequences, or user device data.

8. The method of claim 1, wherein normalizing comprises linearly weighting the weights of the measures of degrees between the first node and the second node and scaling the linearly weighted weights of the measures of degrees to a scale of 1.0.

9. The method of claim 1, wherein the threshold is based on at least one of a first sensitivity set by an entity, a second sensitivity set by the content provider, the content item, the first product, or the second product, and wherein the interaction data comprises a timestamp associated with an event, and user device data.

10. A computer-implemented method for determining full product responses, the method comprising:
receiving, by one or more processing circuits, a product response for a first product and a second product, the product response comprising interaction data indicating a user interaction with a content item of the second product, wherein the content item is associated with a content provider;
calculating, by the one or more processing circuits, a first attribution credit assigned to the product response;
identifying, by the one or more processing circuits, a relatedness graph of the plurality of products;
aggregating, by the one or more processing circuits, weights of measures of degrees of relatedness in the relatedness graph of a first node of the first product to a second node of the second product;
generating, by the one or more processing circuits, a relatedness index based on normalizing the aggregation of the weights of the measures of degrees;
in response to the relatedness index exceeding a threshold, calculating, by the one or more processing circuits, a second attribution credit assigned to a full product response based on the relatedness index; and
providing, by the one or more processing circuits, the first attribution credit and the second attribution credit to the content provider of the content item.

11. The method of claim 10, further comprising:
receiving, by the one or more processing circuits, a pingback correction indicating the full product response was remitted from an entity computing system associated with the first product;
updating, by the one or more processing circuits, the second attribution credit reflecting the remitted product response; and
providing, by the one or more processing circuits, the updated second attribution credit to the content provider.

12. The method of claim 10, further comprising:
identifying, by the one or more processing circuits, a trend in the product response based on analyzing the interaction data and historical interaction data of previous product responses.

13. The method of claim 12, further comprising:
in response to identifying the trend, determining, by the one or more processing circuits, a different content item associated with the first product; and
modifying, by the one or more processing circuits, a content item slot of the content item with the different content item.

14. The method of claim 12, further comprising:
in response to identifying the trend, calculating, by the one or more processing circuits, new weights of the measures of degrees between the first node and the second node; and
updating, by the one or more processing circuits, the relatedness graph with the new weights of the measures of degrees between the first node and the second node.

15. A system comprising:
at least one processing circuit configured to:
receive a product response for a first product, the product response comprising interaction data indicating a user interaction with a content item of a second product, wherein the content item is associated with a content provider;
identify a relatedness graph of a plurality of products;
aggregate weights of measures of degrees of relatedness in the relatedness graph of a first node of the first product to a second node of the second product;
generate a relatedness index based on normalizing the aggregation of the weights of the measures of degrees;
in response to the relatedness index exceeding a threshold, calculating an attribution credit assigned to the product response based on the relatedness index; and
provide the attribution credit to the content provider of the content item.

16. The system of claim 15, the at least one processing circuit further configured to:
receive a pingback correction indicating the product response was remitted from an entity computing system associated with the first product;
update the attribution credit reflecting the remitted product response; and
provide the updated attribution credit to the content provider.

17. The system of claim 15, the at least one processing circuit further configured to:
identify a trend in the product response based on analyzing the interaction data and historical interaction data of previous product responses.

18. The system of claim 17, the at least one processing circuit further configured to:
in response to identifying the trend, determine a different content item associated with the first product; and
modify a content item slot of the content item with the different content item.

19. The system of claim 17, the at least one processing circuit further configured to:
in response to identifying the trend, calculate new weights of the measures of degrees between the first node and the second node; and
update the relatedness graph with the new weights of the measures of degrees between the first node and the second node.

20. The system of claim 15, wherein the product response further comprises the second product, and wherein the at least one processing circuit is further configured to:
update the attribution credit reflecting product response comprising the first product and the second product;
provide the updated attribution credit to the content provider.
